(19) United States
(12) Patent Application Publication
(10) Pub. No.: US 2005/0149966 A1
(43) Pub. Date: Jul. 7, 2005

(54) Interactive television alert manager

(76) Inventors: Jon Arthur Fairhurst, Camas, WA (US); Henry Y. Fang, Cerritos, CA (US); Bryan Severt Hallberg, Vancouver, WA (US); Mark Gregory Hanley, Skamania, WA (US); Vishnu Kumar Shivaj Rao, Vancouver, WA (US); Jeffrey B. Sampsell, San Francisco, CA (US)

Correspondence Address: Graciela G. Cowger;MARGER JOHNSON & McCOLLOM, P.C., 1030 SW Morrison Street, Portland, OR, 97205, US

(21) Appl. No.: 10/910,932

(22) Filed: Aug. 3, 2004

Related U.S. Application Data
(60) Provisional application No. 60/535,047, filed on Jan. 6, 2004.

(51) Int. Cl. G06F 15/173; H04N 7/16; H04N 7/025; H04N 7/10; G06F 3/00; H04N 5/445; G06F 13/00

(52) U.S. Cl. 725/32; 725/136

(57) ABSTRACT

The invention relates to an improved interactive television having an alert manager. The alert manager alerts a viewer of events. For example, the alert manager alerts the viewer that email has arrived in his inbox or that a text message has been sent to his computer. The alert manager manages event alerts in an easy and non-intrusive manner to enhance the viewer's experience.

This application claims priority from U.S. Provisional Application No. 60/535,047 filed Jan. 6, 2004, which we incorporate by reference.

### FIELD

This invention relates generally to a television and, more particularly, to an improved interactive television having an alert manager.

### BACKGROUND

Interactive televisions often contain a wide variety of simultaneously executing applications. The different applications may need to alert the viewer of important events, such as incoming messages, expiring timers, favorite show beginnings, and the like. The viewer may wish to interact with the events immediately, simply cancel the event, or interact with the event at a later time. The events may last for either limited or indefinite time durations. While the television alerts the viewer of the event, the alert should not overly obscure the currently displayed content, e.g., broadcast channel, application, and/or function. This is because the alert may become an unwelcome viewer distraction. And managing alerts should not be overly complicated.

Accordingly, a need remains for an improved interactive television that includes an alert manager that allows the viewer to program and service event alerts with minimum distraction and easy interaction.

### BRIEF DRAWING DESCRIPTION

The foregoing and other objects, features, and advantages of the invention(s) will become more readily apparent from the detailed description of invention embodiments that references the following drawings.

FIG. 1 is a block diagram of a television system embodiment that implements the alert manager.

FIG. 2 is an exemplary remote control including an alert manager key.

FIG. 3 is an exemplary alert manager sequence.

FIG. 4 is an exemplary alert manager sequence.

FIG. 5 is an exemplary alert manager menu layout.

FIG. 6 is an exemplary alert manager sequence without viewer interaction.

FIGS. 7 and 8 are exemplary alert manager sequences with viewer interaction.

### DETAILED DESCRIPTION

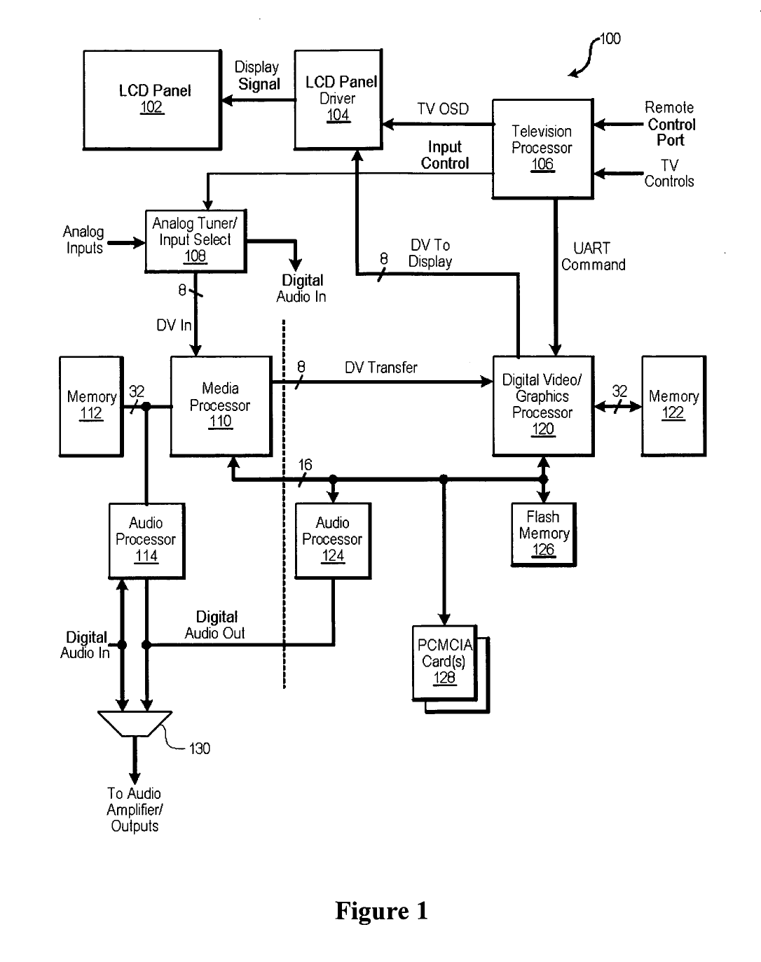

FIG. 1 is a block diagram of a television system embodiment that implements the alert manager of the present invention. The alert manager that programs, displays, and otherwise manages event alerts may be implemented in one or a plurality of the blocks shown in FIG. 1. The television 100 includes a panel 102 having a fixed pixel structure, e.g., liquid crystal display (LCD), plasma display, and the like. For simplicity, we refer to panel 102 as an LCD panel. The LCD panel 102 displays visual output to a viewer based on a display signal generated by an LCD panel driver 104. LCD panel driver 104 accepts a primary digital video signal in any of a variety of well-known digital video formats. In an embodiment, the LCD panel 102 accepts a primary digital video signal in a CCIR656 format (eight bits per pixel YC_{b}Cᵣ, in a “4:2:2” data ratio wherein two C_{b} and two Cᵣ pixels are supplied for every four luminance pixels) from a digital video/graphics processor 120.

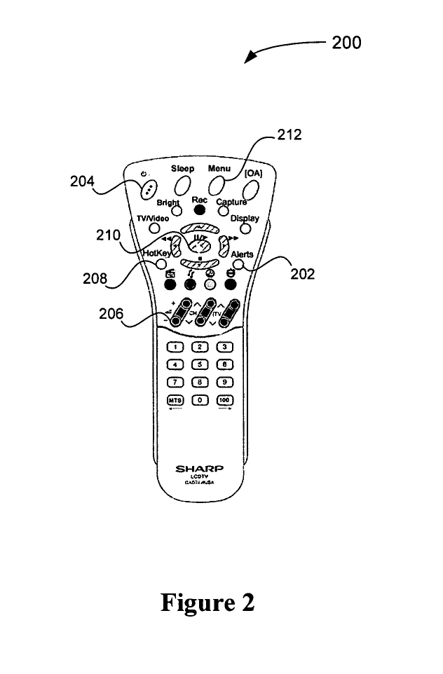

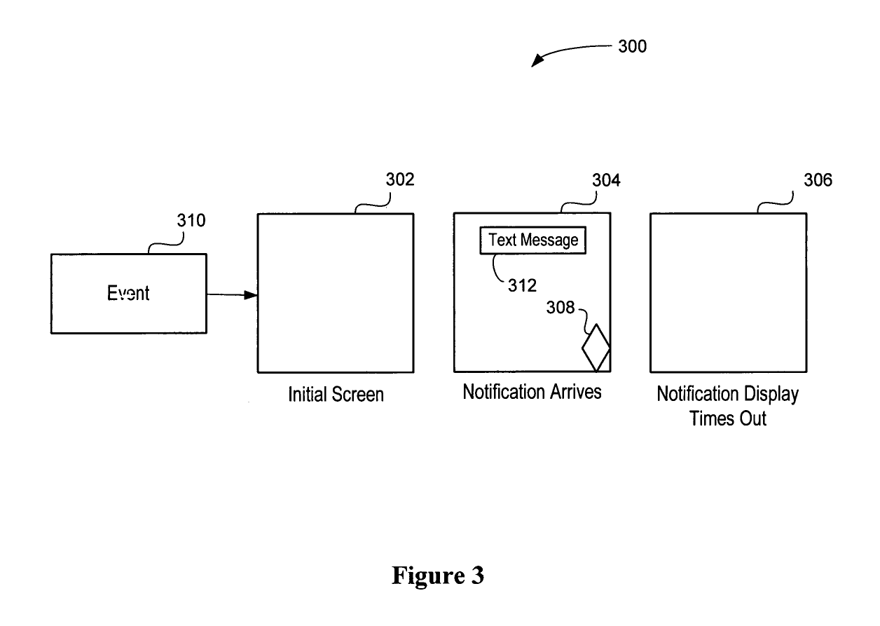

A television processor 106 provides basic control functions and viewer input interfaces for television 100. Television processor 106 receives viewer commands, both from buttons located on the television itself (TV controls) and from a handheld remote control (FIGS. 2-3) through the Remote Control Port. The Remote Control Port may accept input from the remote control in a variety of manners including infrared and radio waves as are well known in the art.

Based on the viewer commands, television processor 106 controls an analog tuner/input select section 108, and also supplies viewer inputs to a digital video/graphics processor 120 over a digital signal transmitter. In an embodiment, the processor 106 provides viewer inputs to the video/graphics processor 120 over a Universal Asynchronous Receiver/Transmitter (UART) command channel.

Television processor 106 generates basic On-Screen Display (OSD) graphics, e.g., graphics indicating which input is selected, the current audio volume setting, balance settings, and the like. Television processor 106 supplies these OSD graphics as a TV OSD signal to LCD panel driver 104 for overlay on the display signal.

Analog tuner/input select section 108 allows television 100 to switch between various analog (or possibly digital) inputs for both video and audio. Video inputs can include a radio frequency (RF) signal carrying broadcast television, digital television, and/or high-definition television signals, NTSC video, S-Video, and/or Red Green Blue (RGB) component video inputs, although various embodiments may not accept each of these signal types or may accept signals in other formats (such as PAL). The selected video input is converted to a digital data stream, DV In, in CCIR656 format (or other formats) and supplied to a media processor 110.

Analog tuner/input select section 108 also selects an audio source, digitizes that source if necessary, and supplies that digitized source as Digital Audio In to an Audio Processor 114 and a multiplexer 130. The audio source can be selected—independent of the current video source—as the audio channel(s) of a currently tuned RF television signal, stereophonic or monophonic audio connected to television 100 by audio jacks corresponding to a video input, or an internal microphone.

Media processor 110 and digital video/graphics processor 120 provide various digital feature capabilities for television 100, as will be explained further in the specific embodiments below. In some embodiments, processors 110 and 120 can be TMS320DM270 signal processors, available from Texas Instruments, Inc., Dallas, Tex. Digital video/graphics processor 120 functions as a master processor, and media processor 110 functions as a slave processor. Media processor 110 supplies digital video, either corresponding to DV In or to a decoded media stream from another source, to digital video/graphics processor 120 over a DV transfer bus.

Media processor 110 performs video coding and decoding of digital media streams for television 100, as instructed by digital video/graphics processor 120. In an embodiment, media processor 110 performs MPEG (Moving Picture Experts Group) coding and decoding of digital media streams for television 100 as instructed by digital video/graphics processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by media processor 110. A person of reasonable skill in the art should understand that other bus sizes are possible between the memory 112 and the processor 110.

Digital video/graphics processor 120 coordinates (and/or implements) many of the digital features of television 100. A 32-bit-wide data bus connects memory 122, e.g., two 16-bit-wide×1M synchronous DRAM devices connected in parallel, to processor 120. A 16-bit-wide system bus connects processor 120 to media processor 110, an audio processor 124, flash memory 126, and removable PCMCIA (Personal Computer Memory Card International Association) cards 128. A person of reasonable skill in the art should understand that other bus sizes are possible between the memory 122 and processor 120, audio processor 124, flash memory 126, and removable PCMCIA cards 128.

Flash memory 126 stores boot code, configuration data, executable code such as may be necessary to implement aspects of the alert manager, Java code for graphics applications, and any other digital data capable of memory storage. PCMCIA cards 128 can provide extended media and/or application capability. Digital video/graphics processor 120 can pass data from the DV Transfer bus to LCD panel driver 104 as is, but processor 120 can also supercede, modify, or superimpose the DV Transfer signal with other content.

Multiplexer 130 provides audio output to the television amplifier and line outputs (not shown) from one of three sources. The first source is the current Digital Audio In stream from analog tuner/input select section 108. The second and third sources are the Digital Audio Outputs of audio processors 114 and 124. These two outputs are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

FIG. 2 is an exemplary remote control 200 including an alert manager key 202. The remote control 200 includes a plurality of buttons to actuate a corresponding plurality of actions, functions, channels, and the like. For example, a power key 204 turns power to television 100 on and off, a volume key 206 regulates audio volume, and a hot key 208 accesses a menu to manage hot key programming. A person of reasonable skill in the art should recognize other buttons on the remote 200 to actuate a plurality of actions associated with the television 100.

Referring to FIGS. 1, 2, and 3, a viewer may access the alert manager through a dedicated alert manager key 202 on the remote control 200, or through a series of menus displayed on the television 100. The viewer may access the series of menus through a menu key 212 on the remote 200.

The television 100 displays broadcast content as well as applications and functions included within the television 100. A person of reasonable skill in the art should understand broadcast content to include any signal capable of being received by any of a plurality of receiving means either included with the television 100 or operatively coupled to the television, e.g., satellite dish, antenna, cable, and the like.

The viewer typically initiates interaction with the television 100 responsive to an event 310. In an embodiment, events are created external to the television 100 and provided to the alert manager, e.g., through the Remote Control Port, TV Control, Analog Input, or any other port on television 100. In response to the event 310, the alert manager 300 displays event alerts, e.g., alert 308, at varying times including when the viewer is watching a movie or playing a game. In another embodiment, events 310 are created internal to the television 100, e.g., a timer. A person of reasonable skill in the art should recognize that an event 310 is any circumstance capable of being provided to or happening in the television 100 of interest to a viewer. The technology that provides events 310 is well known to a person of reasonable skill in the art and will not be discussed in any further detail.

After receiving the event 310, the television 100 and, more particularly, the alert manager 300 minimally prompts and/or interacts with the viewer to avoid unnecessary distraction. And the television 100 interacts with the viewer in an intuitive and easy to understand manner without the viewer having to refer to any television operating manual.

The alert manager 300 of the present invention alerts the viewer to events received or otherwise occurring in the television 100. In an embodiment, the alert manager is a graphical user interface, e.g., alert manager 300 and its associated software and/or hardware. The alert manager may be implemented in the television 100 using a combination of digital video/graphics processor 120, flash memory 126, memory 122, and/or other blocks as shown in FIG. 1.

FIG. 3 is an exemplary alert manager 300. The television 100 displays an initial screen 302 showing content. As we explained earlier, the content can be broadcast content, applications, functions, and the like. The alert manager 300 displays an icon 308 and a text message 312 to indicate an event alert responsive to receiving an event 310 (screen 304). The event manager 300 might display one or more alerts corresponding to one or more events 310, either simultaneously or not.

The icon 308 and text message 312 may be small to prevent unnecessary viewer distraction. The alert manager 300 may position the icon 308 and text message 312 at the same location on the display each time it occurs to allow the viewer quick and easy identification, enhancing the viewer's experience. Or the alert manager 300 may position the icon 308 and text message 312 at positions associated with the particular event. That is, the alert manager 300 might position an email icon and associated text message in the top left corner while positioning a telephone icon and associated text message in the bottom left corner.

In an embodiment, the alert manager 300 displays the icon 308 and the text message 312 overlaid with the content so as to not obscure the content minimizing viewer distraction. The alert manager 300 may change the icon 308 and text message according to the event that has occurred. For example, if the alert manager 300 is alerting of an email event, it may display an email icon and the email text. If, conversely, the alert manager 300 is alerting of a phone message event, it may display a phone message icon together with text information relating to the call, e.g., call time and caller identification (if such is available). In an embodiment, software and/or hardware associated with the external or internal event 310 provides a suitable icon 308 and text message 312 for the alert manager 300's display on screen 304.

If the viewer takes no action responsive to the event 310, the alert manager 300 times out display of the icon 308 and the text message 312 at screen 306. The alert manager 300 may display the icon 308 and/or text message 312 for a predetermined or programmable time. Alternatively, the viewer may remove the icon 308 and/or text message 312 by pressing a predetermined or any button, e.g., alert button 202, on the remote control 200 as we explain in more detail below.

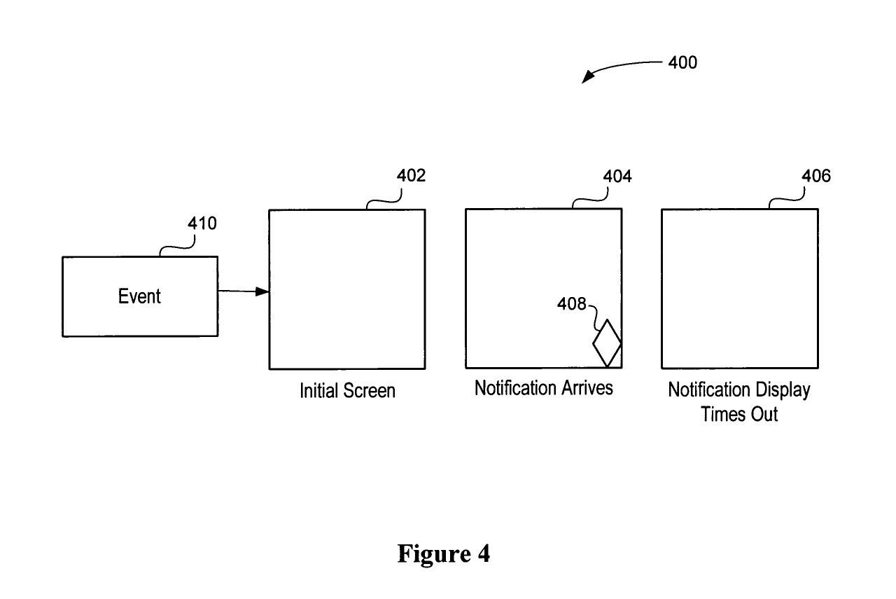

FIG. 4 is an exemplary alert manager 300. At screen 302, the alert manager 300 displays an initial screen 402 showing content. The alert manager 300 displays an icon 308 to indicate an event alert responsive to receiving an event 310 (screen 404). The event manager 300 might display one or more alerts corresponding to one or more events 310, either simultaneously or not.

If the viewer takes no action responsive to the event 310, the alert manager 300 times out display of the icon 308 at screen 406. The alert manager 300 may display the icon 308 for a predetermined or programmable time. Alternatively, the viewer may remove the icon 308 by pressing a predetermined or any button, e.g., alert button 202, on the remote control 200. Although the sequence is similar to that shown in FIG. 3, here the alert manager 300 does not display a text message 312 since none was part of the event 310.

If the event 310 does not provide an associated icon 308 for display, the event manager 310 displays a generic icon. As with the event shown in FIG. 2, after the alert times out as a result of viewer inaction or at the viewer's actuation of a particular button on the remote 200, the alert manager 300 removes the icon 308 and/or text message 312 from the screen 406.

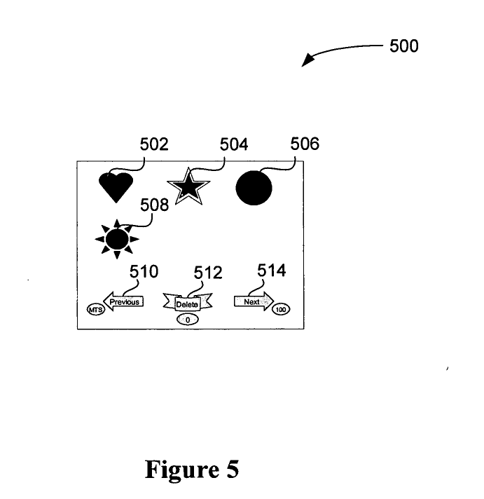

FIG. 5 is an exemplary menu layout 500 of the alert manager 300. The viewer may access the menu layout 500 by actuating an alert key 202 on the remote 200. Alternatively, the viewer may access the menu 500 by any interaction with the television 100, e.g., by actuating a predetermined icon on the television's display 102. The alert key 202 may be appropriately labeled Alert Manager or otherwise on the remote control 200.

The menu 500 allows the viewer to interact with multiple event alerts and respond to specific event alerts. The menu 500 may indicate event alerts with icons 502, 504, 506, and 508. The menu may also use text message, e.g., text message 312 in FIG. 3, in conjunction with the icons 502, 504, 506, and/or 508. In an embodiment, the alert manager 300 permits the queuing of events for the viewer's review, as indicated by the icons 502, 504, 506, and 508. The alert manager 300 may allow queuing without the need for viewer interaction. The alert manager 300 may include icons 510 and/or 514 to indicate the selection of a previous or next icon from those presented. The alert manager 300 may include icon 512 to delete an event alert as represented by the icons 502, 504, 506, and/or 508.

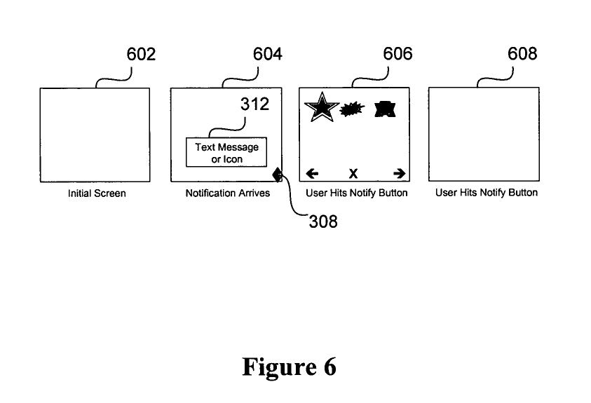

FIG. 6 is an exemplary alert manager 300. The display sequence of FIG. 6 occurs when the alert manager 300 receives an event 310 and the viewer actuates the menu 500 by e.g., pressing alert button 202 on the remote 200. Referring to FIGS. 1-6, the screen 602 displays the viewer's selected content. At screen 604, the alert manager 300 alerts the viewer of its receipt of an event 310 by displaying an icon 308 and/or a text message 312. As before, the icon 308 and/or text message 312 may be overlaid with the content such as to prevent viewer distraction. Responsive to the alert, e.g., icon 308 and/or text message 312, the viewer actuates the alert manager 300's menu 500 (screen 606). The viewer hits the notify button when the particular event is highlighted. The alert button 202 may act as a switch toggling the alert manager 300 (and its associated menu 500) on and off the display. At screen 606, the alert menu 500 is displayed allowing the viewer to view, delete, and otherwise manage the events 310. At screen 608, the menu 500 either times out or is toggled off by the viewer by, e.g., actuating the button 202.

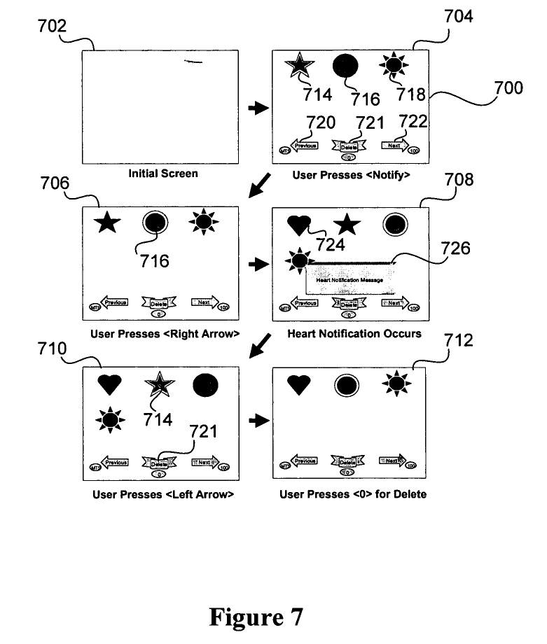

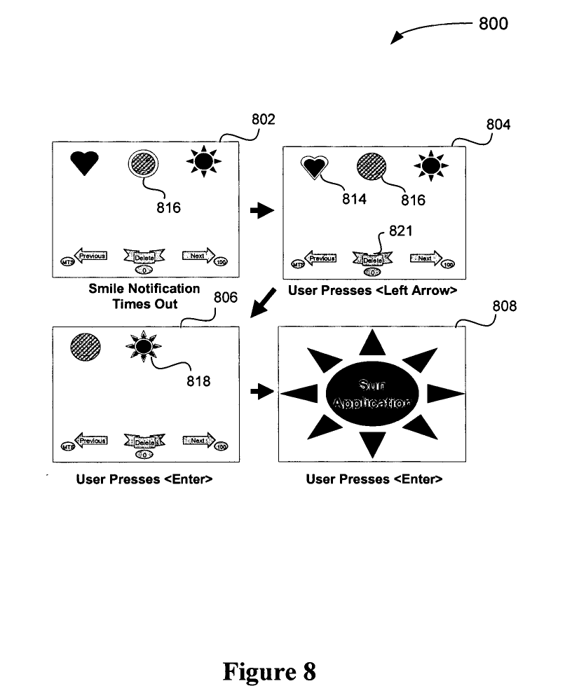

FIGS. 7 and 8 are exemplary alert manager sequences with viewer interaction. Referring to FIGS. 1-8, the screen 702 displays the viewer's selected content. At screen 704, the viewer displays the alert manager 300's menu 500. As before, the viewer may exit the alert manager 300 by actuating (or toggling) the alert key 202 on the remote 200 or by actuating a suitable icon on the display. The menu 500 includes icons 714 to 722. Screen 704 displays three active icons 714, 716, and 718 on the top row with action icons 720, 721 and 722 on the bottom row. The most recent icon may be shown in the upper left corner and is highlighted when the alert manager menu 500 is displayed. Each alert may have a distinct icon associated with it.

At screen 706, the viewer highlights the icon 716 by, e.g., manipulating buttons on the remote 200. Every icon may have a highlighted and a non-highlighted version. The highlighted version is displayed when the cursor is positioned over the icon, as is common practice. The non-highlighted icon is displayed when the cursor is not positioned over the icon, also as is common practice.

Screen 708 shows a new event and associated icon 724 (heart) that occurred while the viewer was reviewing other alerts in the manager 300. The new icon 724 may appear on the upper left corner, as it is the most recent icon. All other icons 714-718 shift right. The icon highlighted before the new the icon was received may retain the cursor's focus (i.e., icon 716 may remain highlighted). The text message 726 associated with icon 724 may appear in the foreground, just as it would if the viewer was not currently in the alert manager 300's menu 500.

Action icons 720, 722, and 721 may be pressed to navigate to a previous screen, a next screen, or to delete a highlighted or active icon, respectively.

Screen 710 shows highlighted icon 714 (star). The viewer presses the delete button 721 to delete the icon 710 as shown at screen 712.

Referring to FIG. 8, the screen 802 shows the expiration of an alert or icon. The alert manager 300 changes the icon 816 to an expired state when the event expires. The alert manager 300 may indicate an icon's (or alert's) expired state by changing its color or by using other such visual and/or audible indicators. The screen 804 highlights icon 814 (heart) and then deletes the icon 814 by pressing delete button 821. The screen 806 shows the icon 814 deleted from view. The alert manager 300 may indicate to the event 310 that the viewer selected and deleted the icon 814 from the manager menu 500. Upon deletion of the highlighted icon, the alert manage may focus or highlight the next latest icon, in this case, the icon 818 (sun). The viewer may run the application associated with the highlighted icon 818 by pressing the enter button 210 on the remote 200.

We have described and illustrated the principles of our invention(s). It should be readily apparent to those skilled in the art that the invention(s) can be modified in arrangement and detail without departing from such principles. We claim all modifications coming within the spirit and scope of the accompanying claims.

1. A television, comprising:
a panel; and
an alert manager operatively coupled with the panel to display an alert responsive to an event.

2. The television of claim 1 where the panel has fixed pixel structure.

3. The television of claim 1 where the panel is a liquid crystal display.

4. The television of claim 1 where the alert manager receives the event from an internal or external source.

5. The television of claim 1 where the alert is an icon.

6. The television of claim 5 where the icon has a shape corresponding to the event.

7. The television of claim 1 where the alert is a text message.

9. The television of claim 1 where the alert manager displays the alert for a programmable time.

10. The television of claim 1 where the alert manager overlays the alert to viewer content on the panel.

11. The television of claim 1 where the alert manager queues one or more alerts associated with one or more corresponding events.

12. The television of claim 1 comprising a remote including an alert button, the remote being operatively coupled with the television.

13. The television of claim 12 where the alert button toggles display of the alert manager.

14. The television of claim 1 where the alert manager displays action icons to manage the alert.

15. An alert manager in a television, comprising:
means for receiving an event; and
means for displaying an alert responsive to the event.

16. The alert manager of claim 15 where the means for receiving include means for receiving alerts generated either internal or external to the television.

17. The alert manager of claim 15 where the alert is an icon.

18. The alert manager of claim 17 where the alert is a text message.

19. The alert manager of claim 15 where the means for displaying display the alert for a programmable time.

20. The alert manager of claim 15 where the means for displaying overlays the alert to viewer content on a panel.

21. The alert manager of claim 15 where the means for displaying queues one or more alerts associated with one or more corresponding events.

22. The alert manager of claim 15 comprising remote means operatively coupled with the television, the remote means including an actuating means to toggle the alert manager on and off.

23. The alert manager of claim 15 where the means for displaying displays action icons to manage the alert.

24. A method of operating a television, comprising:
receiving a first event; and
displaying a first alert responsive to the first event.

25. The method of claim 24 where receiving includes receiving the first event generated internal or external to the television.

27. The method of claim 24 where displaying the first alert includes displaying a first icon associated with the first event.

28. The method of claim 24 comprising:
receiving a second event; and
displaying a second alert responsive to the second event coincident with displaying the first alert.

29. The method of claim 24 comprising managing the first event with a graphical user interface that operates responsive to a remote.

30. The method of claim 29 where managing the event includes deleting the first event.

31. The method of claim 24 where displaying the first alert includes displaying a first icon associated with the first event.

32. The method of claim 31 where displaying the first alert includes displaying a text message associated with the first event.

33. The method of claim 24 where displaying the first alert includes displaying the first alert for a programmable time.

34. The method of claim 24 where displaying the first alert includes overlaying the first alert to content.
